(19) United States
(12) Patent Application Publication
(10) Pub. No.: US 2009/0263563 A1
(43) Pub. Date: Oct. 22, 2009

(54) Method of Preparing Spongy Soy Protein Flakes, Which Contain Coagulated Soy Protein and Soy Oil, From Full Fat, Enzyme Active Soy Flakes, and the Spongy Soy Protein and Soy Oil Containing Flakes Prepared According to Said Inventive Method

(76) Inventors: Itaru "Terry" Tanaka, West Des Moines, IA (US); Safir Moizuddin, Ames, IA (US)

Correspondence Address: STURM & FIX LLP, 206 SIXTH AVENUE, SUITE 1213, DES MOINES, IA, 50309-4076, US

(21) Appl. No.: 12/106,758

(22) Filed: Apr. 21, 2008

(51) Int. Cl. A23L 1/20

(52) U.S. Cl. 426/634

(57) ABSTRACT

The invention relates to method of preparing spongy soy protein and soy oil containing flakes from full fat, enzyme active soy flakes. The inventive method comprises preparing a hot coagulating solution, such as a Nigari salt solution; mixing the full fat, enzyme active soy flakes with the hot coagulating solution, at a temperature and for a time sufficient to deactivate enzymes and other beany- or off-flavor causing constituents, and to precipitate the soy protein in the soy flakes in situ in and on the flakes to form spongy coagulated soy protein and soy oil containing flakes; separating the spongy coagulated soy protein and soy oil containing flakes from the coagulation whey solution; and, washing the separated spongy flakes to remove residual whey solution and any excess salt. Washing can result in white, fluffy, bland tasting spongy flakes. The inventive spongy flakes are excellent as meat extenders and replacers. The spongy flakes can be used, for example, in tacos as a refried bean and meat replacement with excellent taste and texture. The spongy nature of the flakes allows for the addition and absorption of desired flavor and spice constituents.

### CROSS REFERENCE TO RELATED APPLICATIONS

Not applicable.

### FIELD OF THE INVENTION

This invention relates to method of preparing spongy soy protein and soy oil containing flakes from full fat, enzyme active soy flakes. The inventive method coagulates the soy protein in the full fat, enzyme active flakes in situ in and on the flakes themselves resulting a spongy product in flake form containing the coagulated soy protein and soy oil. The method includes contacting the full fat, enzyme active flakes with a hot Nigari type salt coagulating solution. Nigari salt (also spelled “Nagari”) is a by-product of manufacturing sea salt from seawater. Its main constituent is magnesium chloride. It has been used to coagulate soymilk in the production of tofu. Other hot coagulating solutions can be used including calcium sulfate (gypsum) solutions, magnesium sulfate (Epsom salt) solutions, lemon juice, vinegar, and glucanodelatlactone solutions. The inventive method comprises preparing a hot coagulating solution, such as a Nigari salt solution; mixing full fat, enzyme active soybean flakes with the hot coagulating solution, at a temperatures and for times sufficient to deactivate enzymes and other beany- or off-flavor causing constituents; separating spongy flakes containing coagulated soy protein and soy oil from the coagulation whey solution; and, washing the separated spongy flakes to remove residual whey solution and any excess coagulation salt. White, fluffy and bland tasting spongy flakes can be obtained by washing. The added benefit of whey removal and multiple wash in the removal of cooked soy flavor notes and coagulant related aftertaste. The inventive spongy flakes are excellent as meat extenders and replacers. The spongy flakes can be used, for example, as a ground meat substitute, and in total meat and bean paste substitution in tacos, burritos, enchiladas and meat loaf, with excellent taste and texture. The spongy nature of the flakes allows for the addition and absorption of desired flavor and spice constituents. The coagulated spongy flakes retain their shape and acquire, when moistened, a cooked minced or ground meat texture.

The invention also includes the spongy flakes containing coagulated soy protein and soy oil prepared by the inventive method.

The spongy nature of the inventive flakes makes them excellent for absorbing various flavors including spice flavors. The inventive sponge soy protein flakes are bland and excellent as meat extenders and replacers. The inventive spongy flakes contain both coagulated soybean protein and soybean oil. The inventive spongy flakes can be washed to produce white, fluffy and bland tasting flakes useful as a meat extenders or replacers. The inventive spongy flakes are also useful in making a scrambled egg-type product, and have characteristics similar to cooked minced and ground meats. The inventive spongy flakes have excellent moisture and flavor absorption and retention. The inventive spongy flakes can also be dried for extended shelf life. The inventive spongy flakes make a healthy meat alternative, replacer and extender; such as a healthy minced or ground meat alternative. The inventive spongy flakes are highly useful in creating all new healthy vegetarian menus. They have great taste and are very economical as compared with meats; and, are easily incorporated in a variety of food products.

### BACKGROUND AND DESCRIPTION OF RELATED ART

Soybean have long been a staple of the Asian diet in multiple food forms including tofu and soy milk, among many other soy based and fermented foods. Soybeans are excellent sources of protein and oil. Enzyme active soy protein, i.e., soy protein which has not been denatured, has a desirable amino acid profile for nutritional purposes, and includes other health promoting elements such as phytoestrogens. Whole soy foods such as tofu, edamame, and tempeh have long been part of the traditional Asian cuisine. Epidemiological evidence for the health benefits of soy in Japan and other Asian populations is very strong. Soy products are eaten at almost every meal. Japanese women on traditional diets have much lower rates of breast cancer than Western women. Japanese men on traditional diets have much lower rates of prostate cancer than American men. In general, substituting soy foods for some meat and dairy reduces you intake of saturated fat, provides fiber and nutrients, and adds variety to meals.

In recent years the demand for soy foods has grown dramatically in the United States and other western countries, principally in the form of meat analogues, nutrition bars and powdered nutrition beverages prepared from soy protein isolates and concentrates. Chemically fractionated soy ingredients and soymilk are prepared by modernized methods to reduce much of the traditional “beany” flavor favored in the East, but severely objected to in the West. Demand for natural and organic foods has grown at an extraordinary rate. Foods designated “natural” and/or “organic” generally cannot utilize chemically processed foods. The soy ingredients commonly used today are not full fat or oil, having been treated with solvents such as hexane to remove fats and oils. The terms “fats” and “oils” are used interchangeably with respect soybean ingredients, both in the prior art and in this application. Defatted concentrates or isolates do not quality as natural or organic, as has been increasingly popular. U.S. Pat. Nos. 6,495,140 and 6,426,111 illustrate preparation of soy fractionates and/or isolates using solvent extraction.

The soybean flakes useful in the present inventive method are made from full fat, enzyme active, dehulled soybeans, such as made according to the disclosure in U.S. Pat. No. 4,895,730. The spongy flakes of the present invention containing coagulated soy protein and soy oil are made from full fat, enzyme active, dehulled soybeans. This '730 patent is incorporated herein by reference, and is assigned to MicroSoy Corporation, 300 East MicroSoy Drive, Jefferson, Iowa 50129. The full fat, enzyme active soybean flakes used in the present invention qualify as “natural”; and when prepared from soybeans qualifying as organically grown, also qualify as organic food stuffs.

Full fat, enzyme active (i.e., wherein the proteins are not denatured), dehulled soybeans are excellent sources of elements necessary for good health, and supply outstanding nutritional and nutraceutical benefits. Undenatured soybeans and soybean flakes are excellent sources of protein, iron, vitamin-B, calcium, lecithin and isoflavones. In particular, the lecithin content is about 2.7 to 3.1 percent. Soybeans also contain essential minerals including phosphorus, which is an essential element used for building bones. Soy isoflavons are now considered beneficial in reducing risks of cancer, heart disease, and osteoporosis. Pure soya contains from 38-42% protein, 18-22% fat or oil (of this lecithin is 2.7-3.1%), 25-35% carbohydrate, 1.5-2.5% minerals, 3-5% fiber, and 5-6% water. Full soya flour provides about 89 grams of protein per 1000 calories, i.e., about 132 grams of protein and 44 grams of oil per 1000 grams. By contrast, potatoes contain only about 21 grams of protein per 1000 calories. Moreover, potatoes are in the night shade family and are contraindicated for persons prone to or suffering from certain types of arthritis. In addition, since soybeans do not contain particular glutens, products containing substantial amounts of soybeans offer an alternative for people suffering from celiac disease and/or gluten allergies. The spongy flakes of the present invention contain large amounts of soy protein, and provide the above benefits when used in the average diet. Further, the inventive spongy flakes contain at least about three times the grams of protein per 1000 grams as lean beef. A typical analysis of soy flour and soy grits appears in “The Soybean Digest”, Vol. 19, No. 8, June 1959, pages 8 to 9, as follows:

| | Full | High | Low | |
|---|---|---|---|---|
| | Fat | Fat | Fat | Defatted |
| Protein % | 40.0 | 45.0 | 48.0 | 52.0 |
| Fat % | 20.0 | 15.0 | 5.0 | 0.5 |
| Fiber % | 2.5 | 2.5 | 3.0 | 3.0 |
| Ash % | 5.0 | 5.0 | 5.5 | 6.5 |
| Moisture % | 8.0 | 8.0 | 8.0 | 8.0 |

As shown in FIG. 2, MicroSoy® full fat, enzyme active soybean flakes (MSF IGX02) contains 8.27 grams of moisture per 100 grams; and, on a dry weight basis 43.46% protein, 22.37% oil, 29.07% carbohydrate, 11.60% fiber, and 4.67% ash. The spongy flakes produced by the present inventive method contain, as set forth in FIG. 2, 71.16 grams of moisture per 100 grams; and, on a dry weight basis 50.80% protein, 26.35% oil, 18.83% carbohydrate, 5.5% fiber and 1.16% ash. Thus, the inventive spongy flakes unexpectedly and significantly contain on a dry weight basis over 17% more protein than the starting soybean flakes; about 4% more oil; and, less about 10% less carbohydrates.

There exists in the prior art need for soybean and soy protein enriched products, having good taste, texture, and which can be processed using standard food processing equipment. There is an especial need in the prior art for meat and bean substitutes, analogues, and extenders. These products should themselves have a bland taste, and yet be capable of absorbing or taking on desired flavors including spice flavors. The present inventors and the prior art faced the problem that unfortunately products containing large amounts of soybeans tend to exhibit undesirable taste and/or texture. For example, products containing large amounts of soy materials may exhibit unpleasant characteristics including chalkiness, and/or mouth dryness, grittiness, grassy flavor, salty flavor, and astringency. The present inventors also faced the problem that the amounts of soy flakes and like soy materials which could be used in various compositions, including meat or bean substitutes, analogues and extenders, was limited by beany and other objectionable flavors. These problems often required the use of expensive triple null variety soybeans. The present invention provides an unexpectedly excellent solution to the enumerated problems faced by the prior art.

The present inventors have discovered a method of preparing spongy soy protein and soy oil containing flakes from soy flakes made from full fat, enzyme active, dehulled soybeans, which virtually eliminates the beany or off-flavors associated with soy materials. The present inventive method provides spongy soy protein and soy oil containing flakes, which are bland and make an excellent substitutes, analogues, and extenders for meat and bean foodstuffs. The spongy flakes can be used, for example, as a refried bean and meat replacement with excellent taste and texture in, for example, tacos, burritos, enchiladas and meat loaf. The coagulated spongy flakes retain their shape and acquire, when moistened, a cooked minced or ground meat texture. The spongy nature of the inventive flakes allows for the addition and absorption of desired flavor and spice constituents. Unexpectedly and surprisingly, the spongy flakes of the present invention, as shown in FIG. 2, have a higher percentage, on a dry weight basis, of protein and of oil, than the starting full fat, enzyme active starting flakes (denoted MSF 1GX02 in FIG. 2). As also shown in FIG. 2, the inventive spongy flakes contain 50.80% protein and 26.35% oil, as compared with the 43.46% protein and 22.37% oil in the starting soybean flakes.

Importantly, there is virtually no loss in the proteins present in the starting flakes, and very little loss of oils. Quite surprisingly and unexpectedly there is a significant reduction in percentage carbohydrate in the inventive spongy flakes, as compared with the starting full fat, enzyme active flakes. The spongy flakes contain only 18.83% carbohydrates on a dry weight basis, as compared with the 29.07% carbohydrate content of the starting soybean flakes. This is due in large part to dissolution of soluble sugars in the starting soybean flakes, including raffinose and stachyose, into the hot coagulant solution, which soluble sugars are then removed in the coagulant whey solution during separation of the from the product spongy flakes from the coagulant whey solution, and are further removed from the spongy flakes during washing of the residual whey solution therefrom. These sugars are responsible for generation of gas and a bloated feeling experienced by certain people when including soy materials in their diets. This dissolution and removal of sugars during the present inventive process is highly beneficial, not only in reducing the percent carbohydrates in the spongy flakes, but also in preventing gas and bloating experienced by certain people, who would like to include more soy products and protein in their diets.

Tofu and tofu-like products have long been made by adding various soy protein coagulating materials to soy milks. The coagulating materials have included salts, such as Nigari salts which are predominantly magnesium chloride obtained as a by-product of recovering salts from sea water or other brines, various acids including lemon juice and vinegar, and other chemicals including calcium sulfate and magnesium sulfate (Epsom salt).

The present invention differs from traditional methods of making tofu and other soy products in that the stating material is soybean flakes made from full fat, enzyme active, dehulled soybeans, such as made according to the disclosure in U.S. Pat. No. 4,895,730, mentioned and discussed previously (see detailed discussion under “PRIOR ART”). In the present inventive method, the full fat, enzyme active flakes are mixed with a hot coagulating solution, such as a solution of Nigari salt, whereby virtually all the protein in the starting flakes are coagulated and precipitate in situ in and on the flakes, thereby producing flake having a spongy texture and containing the coagulated soy protein and soy oil in the starting soybean flakes in spongy flaked product. The contact of the soybean flakes with the hot coagulating solution is carried out at a temperature and for a time sufficient to deactivate the enzymes and other materials which cause beany or other off-flavors. The spongy soy protein and soy oil containing flakes are separated from the precipitating solution, and then may be washed to produce white, fluffy and bland tasting spongy flakes, highly useful as a meat extenders, analogues and replacers. Virtually no protein and almost no oil are lost during the inventive process.

### PRIOR ART

U.S. Pat. No. 4,895,730, assigned to MicroSoy, relates to apparatus for producing full fat, enzyme active soybean flakes from dehulled soybeans. These flakes are of the type preferred for use in the present invention. The patent discloses preparing soymilk from the flakes.

U.S. Pat. No. 4,172,828 illustrates processing soy protein from defatted soybean flakes. The flakes are mixed with water and heated to an elevated temperature of from about 55 to 70° C. to extract solubles therefrom. The extract liquor is then cooled over a period of time of at least one to three hours resulting in curds and whey. The curds are separated from the whey and preserved by freeze- or spray-drying. The curd can be redissolved in water, precipitated by addition of acid, followed by washing, pH adjustment and drying.

U.S. Pat. No. 5,086,166 illustrates preparing oilseed protein curd products from defatted and undefatted oilseeds, such as soybeans, without undesirable components responsible for poor taste, odor and color. The curds are produced by alkali and water extraction of the proteins from the insoluble components. Ultrafiltration is used to concentrate the desirable high molecular weight protein macromolecules from the smaller less desirable ones. Further treatment with heat, acid and/or salt coagulates the protein as a meat-like, chewy curd which will not disintegrate when boiled. The curd is described (paragraph in “Field of the Invention”) as “ranging from a firm, chewy meat-like product to a softer, moister, spongy product” that is “bland in taste so as to permit its flavor and color enhancement by addition of desired seasonings and food colors.” The further treatment with heat, acid and/or salt is disclosed as being carried out from about 80° C., most preferably above 90° C., and approaching 100° C.; but, that temperatures above 100° C. are not preferred because of risk of undesirable excessive protein denaturing {paragraph two in “SUMMARY OF THE INVENTION”).

U.S. Pat. No. 4,818,558 discloses a method of making a fibrous tofu food product comprising dispersing proteinaceous fibers, such as chopped and fluffed wet spun soy isolate fibers, in soymilk to form a mixture. This step is followed by adding an edible acid (or acids), calcium and/or magnesium salts, to co-precipitate a coagulative mixture. The resulting coagulative mixture can then be formed into desired sizes and shapes. The patent describes (paragraph two of “BACKGROUND OF THE INVENTION”) traditional tofu manufacture wherein soybeans are soaked, ground, mixed with water, heated to produce a slurry, and filtered so that the ground insoluble soybean residue is separated from the liquid (soymilk). The resulting curd is separated from the soymilk by the use of acids and/or salts.

U.S. Pat. No. 4,132,809 illustrates preparing a meat substitute or extender base derived from textured soy protein particles and a “functional protein source” such as whey solids, skim milk solids, egg solids and/or wheat gluten. The end product is said to exhibit a “moist spongy texture”; and, when flavored, to make an excellent extender and tasty substitute for natural beef or other meat products. The patent process comprises the initial steps of (1) moisture cooking textured soy protein particles in 1-3% by weight common salt (NaCl) solution until the particles become soft and pliable; (2) drying the cooked particles to a moisture content of 30-60% to produce a matrix; (3) adding a functional protein source to the matrix; and, (4) kneading and grinding the protein-matrix mixture to disperse the functional protein source intimately in the matrix. These steps are followed by several succeeding steps to arrive at the final product mixture. Note first paragraph of “DESCRIPTION OF PREFERRED EMBODIMENT OF INVENTION” of the patent.

U.S. Pat. No. 3,914,443 illustrates preparing a “heat-denatured soybean protein capable of gel forming” by (1) desolventing a defatted soybean material; (2) extracting a protein from the defatted soybean by water or alkali; (3) removing insoluble impurities from the extracted soybean protein solution; and, (4) redissolving with an alkali a protein curd obtained by subjecting the protein solution to isoelectric point precipitation. EXAMPLE 1 illustrates using hexane extracted soybean flakes, which after desolventing using blown live steam, are pulverized to form a heat denatured, defatted soybean flour. This disclosure differs from the present invention in that the flakes are defatted, ground to a flour, dissolved in solution, insoluble impurities filtered off, the defatted soy protein precipitated from the solution remaining after filtration by isoelectric point precipitation, and then redissolving the precipitated defatted soy protein.

U.S. Pat. No. 7,332,192 similarly shows producing a soy protein isolate having desirable flavor and stability characteristics. The patent process comprises (4th paragraph of “SUMMARY OF THE INVENTION”) dispersing white flakes produced from soybeans in a liquid to produce a soy protein extract, and separating the insoluble material from the soy protein extract. The pH of the soluble soy protein extract is then adjusted to about the isoelectric point of soy protein with an acid to form a precipitated soy protein mixture. The precipitated soy protein mixture is then centrifuged and the supernatant liquid decanted off from the resulting soy protein curd. The soy protein curd is then subjected to several further processing steps.

U.S. Pat. No. 3,950,564 is illustrative of prior art wherein a soy-based meat substitute is prepared by extruding to produce aligned fibrous masses.

U.S. Pat. No. 4,044,157 shows preparing expanded soybean granules by heating a dough made of defatted solvent extracted soybean protein to temperatures between about 260 to 380° F. to rapidly denature the protein followed by extruding the heated dough.

U.S. Pat. No. 4,770,523 illustrates apparatus for producing soybean flakes by cooking raw soybeans and squashing the cooked soybeans into flakes. The soybeans are steam heated and cooked in a pressure cooker such that the “toxic substances contained in the raw soybeans are deactivated and the smell of soybean is eliminated.” The cooked soybeans are squashed into flakes by a roll mill, dried and cooled in a dryer/cooler unit. This patent appears (note fourth paragraph from end of patent specification) to employ whole hulled, as opposed to dehulled, soybeans.

### SUMMARY OF THE INVENTION

It is an object of the present invention to make spongy soy protein and soy oil flakes having a bland flavor, capable of absorbing flavors and spice flavorings, and having excellent texture and mouth feel. The inventive spongy flakes, containing coagulated soybean protein and soy oil, are highly useful as a meat and bean substitutes, analogues and extenders, such as in vegetarian hamburgers, as well as, in tacos, burritos, enchiladas, and meat loaf. It is a further object of the present invention to provide a method of coagulating the soy protein and oil contained in soy flakes, made from full fat, enzyme active, dehulled soybeans, into a spongy flake structure, and simultaneously deactivating the enzymes and other materials which result in undesirable beany and other off-flavors. The bland spongy flake product of the present invention is prepared using the present inventive method. The present invention differs from traditional methods of making tofu and other soy products in that the stating material is soybean flakes made from full fat, enzyme active, dehulled soybeans, such as made according to disclosure U.S. Pat. No. 4,895,730. The present inventive method comprises the steps of mixing the full fat, enzyme active flakes with a hot coagulating solution, such as a solution of Nigari salt, whereby virtually all the soy protein in the starting flakes is coagulated in situ on and in the flakes, thereby maintaining the flake structure and producing a coagulated soy protein and soy oil containing spongy flake product. The spongy flakes are then from the remaining coagulating whey solution. The contact of the soybean flakes with the coagulating solution is carried out at a temperature and for a time sufficient to deactivate the enzymes and other materials which cause beany or other off-flavors. The spongy soy protein and soy oil containing flakes, after separation from the coagulating solution, are then be washed to produce the inventive spongy flake product. Multiple washings result in white, fluffy and bland tasting spongy flakes, highly useful as a meat extenders, analogues and replacers. Virtually no protein and almost no oil are lost during the inventive process.

The spongy soy protein and soy oil containing flakes constitute a further object of the present invention. The beneficial characteristics of the spongy coagulated soy protein and soy oil containing flakes are unexpectedly achieved by the present inventive method. These spongy flakes differ from prior art tofu products in that are in highly useful spongy flake form; contain virtually all of the soy protein and soy oil found in the stating full fat, enzyme active flakes; are bland in taste without beany or other off-flavors; are spongy and readily absorb various flavors including spice flavors; have good mouth feel; and, are excellent as meat and bean extenders, substitutes and analogues. For example, the inventive spongy flakes are excellent substitutes for meat, beans and refried b beans in tacos, burritos, enchiladas, hamburgers, and meat loaf. These beneficial and useful properties are the unexpected result of using full fat, enzyme active flakes as starting material, and coagulating and depositing the protein material in situ on the existing flake structure of the starting flakes by contacting the starting flakes with a hot coagulating solution. Additionally, the spongy flakes containing the coagulated soy protein and soy oil are easily separated from the supernatant coagulating whey solution; and, easily washed to produce white, fluffy and bland tasting spongy flakes containing the coagulated soy protein and soy oil.

As is apparent, there are numerous significant differences between the present invention and the cited prior art patents. In the cited prior patents, the soybeans or other soybean materials are subjected to various steps including soaking, grinding, mixing with heated water to extract soy protein, and filtration, such as ultra-filtration to separate the soy protein solution from the insoluble constituents. The starting soybean flakes, useful in the present inventive method and in making the inventive spongy soy protein and soy oil containing flakes, are made from full fat, enzyme active, dehulled soybeans, such the method found in the disclosure in U.S. Pat. No. 4,895,730. The spongy flakes of the present invention are easily separable from the coagulating solution, such as by simple decantation and/or filtration. Moreover, the soy proteins in the present invention are not dissolved into the coagulating solution to be separated in solution from the residue, but are simultaneously dissolved and precipitated on and in the soybean flakes in situ, whereby the flake form of the starting soybean flakes is retained in the product spongy flakes. The spongy flakes of this invention retain virtually all of the soy protein and soy oil in the starting full fat soybean flakes. The prior art patents require separation of the solution containing the dissolved soy protein, such as by ultrafiltration, and then precipitation of the dissolved soy protein from the separated solution by coagulation with acid and/or various salts to produce a soy protein curd. In the prior art patents the soy oils are usually removed from the starting materials, such as by solvent extraction with hexane. Unlike in the prior art patents, the starting soybean materials used in the present invention are in the form of full fat, enzyme active soybean flakes, prepared from dehulled soybeans. Neither the soybeans nor the flakes are deoiled; and, the flakes are processed in flake form, without being ground or broken up. Further, in the present invention, the flakes are mixed with a hot Nigari type salt solution to simultaneously dissolve and coagulate the soy protein directly into and on the flakes, thereby retaining the flake structure thereof. In the prior art the soy protein is dissolved into solution and must be recovered, after separation from the insoluble residue, from the solution by addition of a coagulating medium. In the present invention the soy protein is not dissolved and removed from the starting soy material, but dissolved and simultaneously coagulated in situ on the starting flakes, thereby retaining and resulting in a spongy flake structured product. The whey can be separated from the coagulated soy protein and soy oil containing flakes by simple filtration, while retaining the flake-like nature of the coagulated soy protein. In the cited prior art, the soybean materials are usually ground, and mixed with hot water or other hot aqueous solution to dissolve the soy proteins. Also, in the present invention, the deactivation of the off- and beany-flavor causing constituents takes place during and simultaneously with the contacting of the starting soybean flakes with the hot Nigari solution, and precipitation of the spongy soy protein and soy oil containing flakes.

Unexpectedly and surprisingly, the spongy flakes of the present invention, as shown in FIG. 2, have a higher percentage, on a dry weight basis, soy protein and soy oil than the starting full fat, enzyme active flakes (denoted MSF 1GX02 in FIG. 2). The inventive spongy flakes contain 50.80% protein and 26.35% oil, as compared with the 43.46% protein and 22.37% oil, in the starting flakes. Also surprisingly, beneficially, and unexpectedly, the spongy flakes contain significantly less carbohydrate on a dry weight basis (18.83%) than the starting Micro-Soy Flakes (MSF 1GX02), which contain 29.07% carbohydrate.

### BRIEF DESCRIPTION OF THE DRAWINGS

FIG. 1 is a flow chart showing the method steps in the present invention. The starting MicroSoy® flakes are made from full fat, enzyme active, dehulled soybeans, such as the by the method found in the disclosure of U.S. Pat. No. 4,895,730, assigned to MicroSoy. These starting flakes are designated MicroSoy Flakes® (IGX02) in FIG. 1. The starting MicroSoy flakes are mixed with hot coagulant solution for a temperature and time sufficient to deactivate the enzymes and other constituents responsible for odor and beany and off-flavors. The coagulant whey solution is then removed from the resulting spongy flakes containing the coagulated soy protein and soy oil by simple means such as decantation and filtration. A rotary screen and vibrating screen separators can be used. A drum separator with roller press is useful in continuous processing systems. The spongy flakes are the washed to remove residual coagulant whey solution and any excess salt remaining, resulting in a bland spongy flake product free of beany or other off-flavors. The product flakes are spongy and readily absorb various flavors and spice flavors, have good mouth feel, are excellent as meat and bean extender, substitutes and analogues. The spongy flakes contain in coagulated form virtually all of the soy protein and almost all of the soy oil contained in the starting full fat, enzyme active flakes. The spongy flakes can be easily washed to produce white, fluffy and bland tasting spongy flakes containing the coagulated soy protein and soy oil.

FIG. 2 gives the percent moisture, and on a dry weight basis, the percent protein, oil, carbohydrate, fiber and ash, in the starting MicroSoy full fat, enzyme active flakes (MSF 1GXO2). FIG. 2 also gives these percents in the inventive product spongy flakes. FIG. 2 shows, surprisingly and unexpectedly, that the percent protein and the percent oil in the spongy flakes is higher that in the starting MicroSoy flakes. And, even more unexpectedly and beneficially, that the percent carbohydrate, on a dry weight basis, is significantly lower in the product spongy flakes than in the starting MicroSoy full fat, enzyme active flakes.

### DETAILED DESCRIPTION OF THE INVENTION

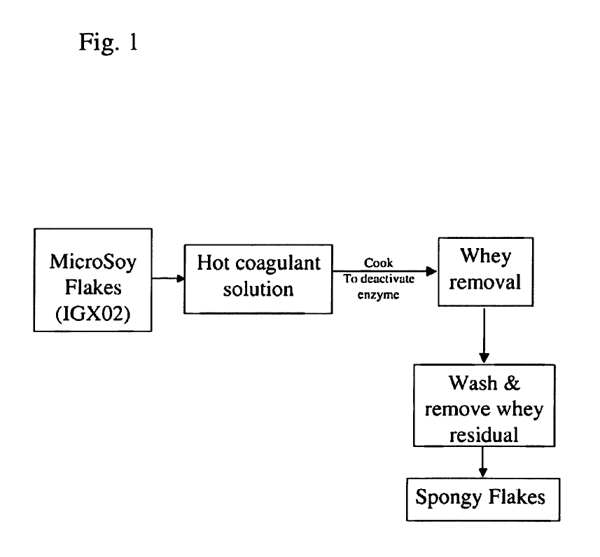

Referring to FIG. 1, there is shown a flow chart of the steps of the present inventive method. In the first step the full fat, enzyme active soybean flakes are mixed with hot coagulant solution at a temperature and for a time sufficient to deactivate the enzymes and other constituents which cause undesirable beany or other off-flavors or odors. The full fat enzyme active soybean flakes are made from full fat, enzyme active dehulled soybeans, preferably as disclosed in U.S. Pat. No. 4,895,730, which patent is incorporated herein by reference. The temperatures sufficient to cause the deactivation fall in the range of from 70-99° C. Preferably, the temperatures fall in the range of from about 90-98° C.; and, even more preferably from 96 to 98° C. The times sufficient to cause the deactivation range from a minimum of 7 minutes and to a maximum of 15 minutes. The most preferred, or best mode, and optimum temperature is about 97° C. and time is about 7 minutes. The hot coagulant solution is preferably a Nigari salt solution (sometimes spelled “Nagari” or “Negari”) having between about 6 and 9 grams of Nigari salt per 100 grams of MicroSoy Flakes per liter of water. Nigari salt is predominantly, if not almost entirely, magnesium chloride. The optimum concentration of Nigari salt in the coagulating solution is 8.6 grams per 100 grams of MicroSoy Flakes per liter of water. Nigari salt is the hexahydrate salt of magnesium chloride (MgCl₂.6H₂O). Adding less Nigari salt will cause some of the protein from the flakes to leach out and not be coagulated, and thus be lost in the whey water. Typically, adding excess Nigary salt will result in making a spongy flake product have an undesirable salty taste and rubbery consistency. However, since the spongy flakes are washed, the excess salt can be removed by washing. Salts other than Nigary salt can be used in the coagulant solution including calcium chloride (CaCl₂), calcium sulfate (CaSO₄.5H₂O), and magnesium sulfate (MgSO₄.7H₂O). Citric acid and glucanodelatlactone (GDL; C₆H₁₀O₆) solutions can also be used as the coagulant solution.

During the mixing and contacting of the full fat, enzyme active flakes with the coagulating solution, within the above disclosed ranges of temperatures and times, the soy protein coagulates or precipitates in and on the soybean flakes in situ forming the spongy flakes of coagulated soy protein and soy oil of the present invention. The soy protein is not removed from the flakes or lost in solution, but coagulates on the soybean flakes as fast as it dissolves and is retained on and in the flakes to form the spongy flake product of the invention.

The coagulant whey solution is then easily separated from the spongy flakes using simple separation techniques, such as decanting and/or simple filtration. The spongy flakes separated from the whey are then washed, removing residual coagulant whey solution and any excess salt. For a simple system in small operations, the spongy flakes and the coagulant whey solution can be poured into a cheese cloth lined pasta or salad washing colander. With the help of the cheese cloth, the spongy flakes can be submerged several times in clean cold water (10-25° C.) or hot water (45-65° C.) for washing. Both cold and hot water wash will remove any remaining residual coagulant whey solution and any excess salt. A hot water wash removes more pigment and makes the product whiter (less yellow), and significantly reduces the coagulant and whey taste. The spongy flakes can be washed to achieve white, fluffy and bland tasting spongy flakes. The spongy nature of the inventive flakes allows for absorption of desired flavors including spice flavors. Hot water wash is preferred when using Nigari (magnesium chloride) or calcium sulfate as coagulants. Separation can also be accomplished using a rotary separator and a vibrating screen. A drum roller separator with roller press works well for continuous operations.

The coagulated spongy flakes retain the flake shape and spongy texture. When moistened, they have as minced or ground meat like texture. Multiple wash steps provides the added benefit of removing cooked soy flavor notes and coagulant related aftertaste. The inventive coagulated spongy flakes find application as total or partial substitutes for mince or ground meats. The spongy flakes are excellent as meat extenders, analogues and replacers. They are highly useful as meat and bean paste replacements and extenders in, for example, tacos, burritos, enchiladas and meat loaf. The exhibit excellent flavor and texture qualities. The inventive spongy flakes exhibit no cooked or raw soy flavor.

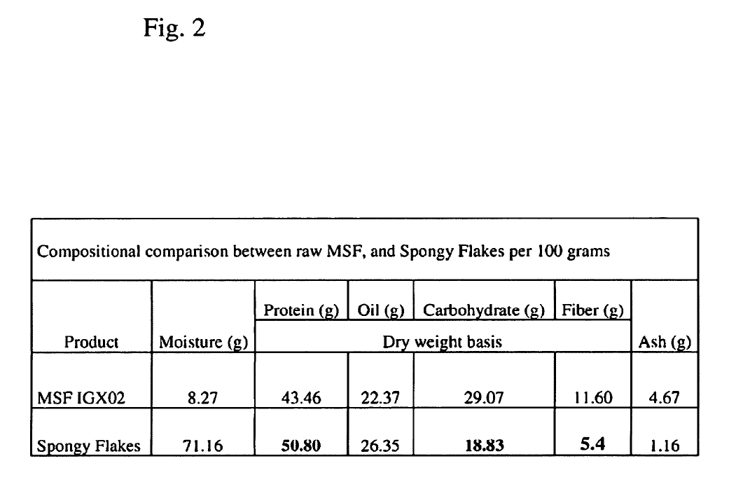

Surprisingly and unexpectedly, as shown in FIG. 2, the inventive spongy flakes have a higher percentage, on a dry weight basis, of soy protein and soy oil than the starting full fat, enzyme active starting flakes. The inventive spongy flakes contain 50.80% protein and 26.35% oil, as compared with the 43.46% protein and 22.37% oil in the starting flakes. Also surprisingly, beneficially and unexpectedly, the spongy flakes contain significantly less carbohydrate on a dry weight basis (18.83%), than the starting enzyme active, full fat flakes, which contain 29.07% carbohydrate. This is due in large part to dissolution of soluble sugars, including raffinose and stachyose present in the starting flakes, into the hot coagulant solution, which are then removed with from the product spongy flakes during separation from the coagulant whey solution and further during washing. The sugars are responsible for generation of gas and a bloated feeling experienced by certain people when including soy materials in their diets. This dissolution and removal of sugars during the present inventive process is highly beneficial, not only in reducing the percent carbohydrates in the spongy flakes, but also in preventing gas and bloating experienced by certain people who would like to include more soy products and protein in their diets.

The washed spongy flakes can be used wet, or stored for short times under refrigeration. For longer storage times the spongy flakes can be dried, and rehydrated at a later time without loss of their spongy characteristics. The inventive spongy flakes are also a good source of all-natural fiber. Most surprisingly the inventive spongy flakes show an unexpected 17% jump in protein over the starting full fat, enzyme active flakes (from 43.46% to 50.80%); and, a more than 8% reduction in carbohydrates (from 29.07% to 18.83%) over the starting flakes. The raffinose and stachyose sugars naturally present in soybeans and the starting flakes are largely removed during the contact with the hot coagulant solution and during washing. These sugars are responsible for gas production in the stomach, and their removal and absence in the inventive spongy flakes is highly beneficial.

1. A method for preparing spongy flakes containing coagulated soy protein and soy oil comprising the steps of:
(1) contacting soybean flakes, made from full fat, enzyme active dehulled soybeans, with a hot soy protein coagulant solution at a temperature and for a time sufficient to
(a) deactivate the enzymes and other constituents responsible for beany and off-flavors; and,
(b) to precipitate the soy protein simultaneously as it dissolves in situ on the flakes to produce spongy coagulated soy protein and soy oil containing flakes and a coagulant solution containing whey liquid;
(2) separating the spongy flakes containing coagulated soy protein and soy oil from the whey liquid; and,
(3) washing the spongy coagulated soy protein and soy oil containing flakes to remove residual whey solution, and any remaining coagulant solution and salt.

2. The method of claim 1 wherein the temperature ranges from 70-99° C.

3. The method of claim 1 wherein the temperature ranges from 90-98° C.

4. The method of claim 1 wherein the temperature ranges from 96 to 98° C.

5. The method of claim 1 wherein the time ranges from a minimum of 7 minutes and to a maximum of 15 minutes.

6. The method of claim 1 wherein the temperature is about 97° C. and the time is about 7 minutes.

7. The method of claim 1 wherein coagulant solution is a hot salt solution.

8. The method of claim 1 wherein the coagulant solution is a hot salt solution, wherein the salt is selected from the group consisting of Nigari salt, magnesium chloride, calcium chloride calcium sulfate, and magnesium sulfate.

9. The method of claim 7 wherein the hot coagulant solution contains between about 6 and 9 grams of salt per 100 grams of soybean flakes per liter of water.

10. The method of claim 7 wherein the hot coagulant solution contains between about 6 and 9 grams of Nigari salt per 100 grams of soybean flakes per liter of water.

11. The method of claim 7 wherein the hot coagulant solution contains about 8.6 grams of Nigari salt per 100 grams of MicroSoy Flakes per liter of water.

12. The method of claim 1 wherein the coagulant solution is a hot solution of citric acid.

13. The method of claim 1 wherein the coagulant solution is a hot solution of glucanodelatlactone.

14. The method of claim 1 wherein the spongy flakes containing coagulated soy protein and soy oil are separated from the whey solution by filtering.

15. The method of claim 1 wherein the spongy flakes separated from the whey solution are washed to remove residual whey solution and any remaining coagulating salt.

16. Spongy flakes containing coagulated soy protein and soy oil prepared by contacting full, fat enzyme active soybean flakes with a hot soy protein coagulating solution.

17. Spongy flakes containing coagulated soy protein and soy oil, prepared from full fat, enzyme active soybean flakes, according to the method of claim 1.

18. Spongy flakes containing coagulated soy protein and soy oil, prepared from full fat, enzyme active soybean flakes, by the steps of:
(1) contacting soybean flakes, made from full fat, enzyme active dehulled soybeans, with a hot soy protein coagulant solution at a temperature and for a time sufficient to
(a) deactivate the enzymes and other constituents responsible for beany and off-flavors; and,
(b) to precipitate the soy protein simultaneously in situ as it dissolves in and on the flakes to produce spongy flakes containing coagulated soy protein and soy oil and a coagulant whey solution;
(2) separating the spongy flakes containing coagulated soy protein and soy oil from the coagulant whey solution;
(3) washing the spongy flakes coagulated soy protein and to remove residual whey solution, and any remaining coagulant salt.
